(19) United States
(12) Patent Application Publication
(10) Pub. No.: US 2014/0196565 A1
(43) Pub. Date: Jul. 17, 2014

(54) BICYCLE BRAKE CABLE COMBINATION FOR DIFFERENT CYCLES

(71) Applicant: CHANG HUI LIN, Chang Hua Hsien (TW)

(72) Inventor: Chang Hui LIN, Chang Hua Hsien (TW)

(73) Assignee: Chang Hui LIN, Chang Hua Hsien (TW)

(21) Appl. No.: 13/743,447

(22) Filed: Jan. 17, 2013

(51) Int. Cl. F16C 1/10

(52) U.S. Cl. CPC F16C 1/102
USPC 74/502.6

(57) ABSTRACT

A brake cable combination includes a cable member having an end member at one end portion, a coupler for one type bicycle having an orifice for engaging with the cable member and an enlarged socket opening for engaging with the end member of the cable member, and another coupler for another type bicycle having an orifice for selectively engaging with the cable member, and an enlarged socket opening for selectively receiving and engaging with the end member of the cable member and for allowing the cable member to be easily and quickly and readily attached or mounted or secured or coupled to the brake handles of different cycles or bicycles.

### BACKGROUND OF THE INVENTION

1. Field of the Invention

The present invention relates to an actuating or operative or pulling cable for cycles, such as bicycles, tricycles, motor cycles, unicycles, etc., and more particularly to an actuating or operative or pulling bicycle brake cable including a structure for adapting or attaching or mounting or securing or coupling to the brake handles and/or the brake devices of different cycles.

2. Description of the Prior Art

Typical cycles, such as bicycles, tricycles, motor cycles, unicycles, etc. each comprise one or more facilities or devices, such as the brake devices or the transmission devices of the cycles that are required to be actuated or operated with one or more actuating or operative or pulling cables.

For example, U.S. Pat. No. 4,308,761 to Shimano, U.S. Pat. No. 4,877,112 to Malinowski, U.S. Pat. No. 5,448,927 to Lumpkin, U.S. Pat. No. 5,515,743 to Lumpkin, U.S. Pat. No. 5,537,891 to Nagano et al., U.S. Pat. No. 5,564,311 to Chen, U.S. Pat. No. 5,584,210 to Gelbein, U.S. Pat. No. 5,660,082 to Hsieh, U.S. Pat. No. 5,669,268 to Tsai, U.S. Pat. No. 5,778,729 to Tsai, U.S. Pat. No. 6,098,488 to Vos, U.S. Pat. No. 6,161,488 to Reddicliffe, and U.S. Pat. No. 6,324,937 to Chen disclose several of the typical brake devices of the cycles each comprising one or more actuating or operative or pulling cables attached or mounted or secured or coupled to the brake devices for actuating or operating the brake devices of the cycles.

However, for different cycles, such as the mountain bicycles, the racing bicycles, or the free style bicycles, different types of actuating or operative or pulling cables are required to be provided or disposed or engaged with the different types of cycles or bicycles; i.e., the actuating or operative or pulling cables for one type of the cycles or bicycles may not be used for fitted or engaged with the other type of the cycles or bicycles, such that the manufacturers or product providers should prepare and provide two or more kinds or types of actuating or operative or pulling cables for fitting or engaging with different cycles or bicycles.

The present invention has arisen to mitigate and/or obviate the afore-described disadvantages of the conventional actuating or operative or pulling cables of the cycles.

### SUMMARY OF THE INVENTION

The primary objective of the present invention is to provide an actuating or operative or pulling bicycle brake cable combination including a structure for adapting or attaching or mounting or securing or coupling to the brake handles and/or the brake devices of different cycles or bicycles.

In accordance with one aspect of the invention, there is provided a brake cable combination comprising a cable member including an end member provided on one end portion thereof, a first coupler for attaching or mounting to a brake handle of one type bicycle, including a first orifice formed therein for engaging with the cable member, and an enlarged first socket opening formed therein and communicating with the first orifice of the first coupler for receiving and engaging with the end member of the cable member, and a second coupler for attaching or mounting to a brake handle of another type bicycle, including a second orifice formed in the second coupler for selectively engaging with the cable member, and an enlarged second socket opening formed in the second coupler and communicating with the second orifice of the second coupler for selectively receiving and engaging with the end member of the cable member. The first coupler and the second orifice are provided for attaching or mounting to different types of cycles or bicycles, such as the mountain bicycles, the racing bicycles, or the free style bicycles, and the cable member is good for fitting or attaching to or engaging with either of the brake handles for different types of cycles or bicycles.

The first coupler includes a barrel or cylindrical shaped-structure having two flat ends, and the first orifice and the first socket opening of the first coupler are formed in a middle portion of the first coupler for selectively engaging with the cable member and the end member.

The second coupler includes a head having the second socket opening formed in the head of the second coupler, and a shank extended from the head and the second orifice is formed in the shank of the second coupler.

The head of the second coupler includes a cylindrical structure, and the shank of the second coupler includes a cylindrical structure. The shank of the second coupler includes an outer diameter no greater than that of the head of the second coupler. The end member of the cable member includes a spherical structure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of an actuating or operative or pulling bicycle brake cable combination in accordance with the present invention for different cycles or bicycles;

FIG. 2 is a partial exploded and cross sectional view of the actuating or operative or pulling bicycle brake cable combination;

FIG. 3 is a partial cross sectional view illustrating the attachment or engagement of the actuating or operative or pulling bicycle brake cable combination with one type of the cycles or bicycles; and

FIG. 4 is another partial cross sectional view similar to FIG. 3, illustrating the attachment or engagement of the actuating or operative or pulling bicycle brake cable combination with the other type of the cycles or bicycles.

### DETAILED DESCRIPTION OF THE PREFERRED EMBODIMENT

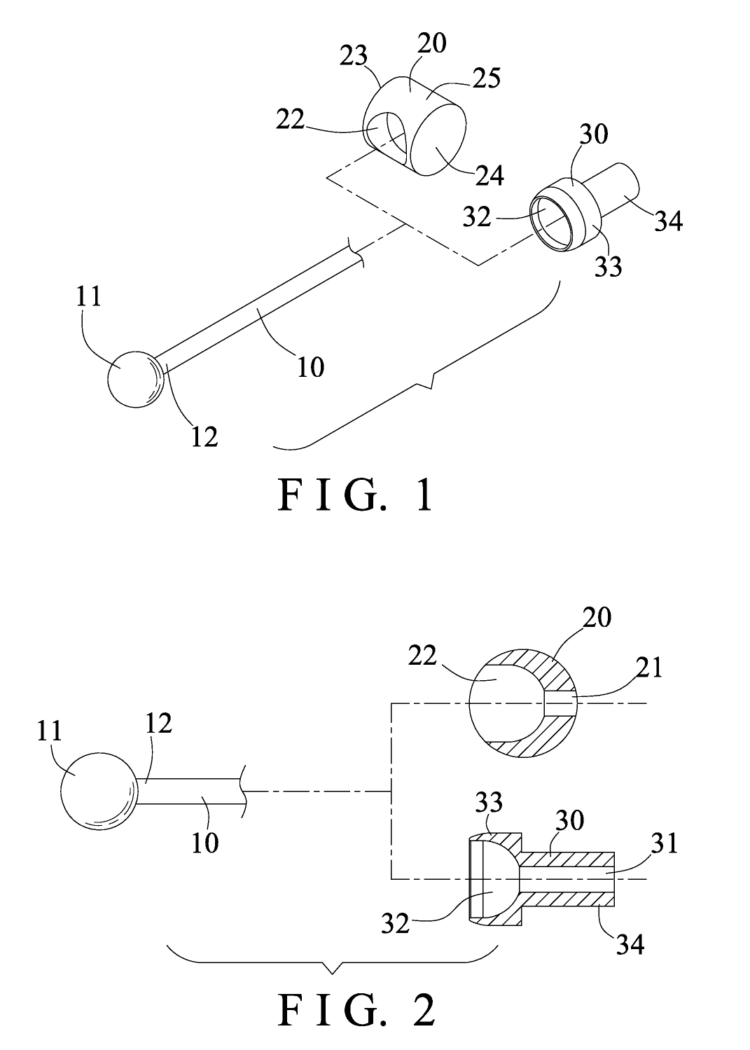

Referring to the drawings, and initially to FIGS. 1 and 2, an actuating bicycle brake cable combination in accordance with the present invention comprises a longitudinal wire or cable member 10 including a pin or gudgeon or wire nipple or post or roller-shaped connector or cast lug barrel or end member 11 formed or provided or disposed or attached or mounted on one end portion 12 thereof, in which the end member 11 preferably includes a barrel or spherical structure, and further comprises two or more heads or cylinders or sleeves or nipples or pull seats or brackets attachment fittings or couplers 20, 30 that are provided for attaching or mounting or securing or coupling to or engaging with the different types of cycles or bicycles, such as the mountain bicycles, the racing bicycles, or the free style bicycles.

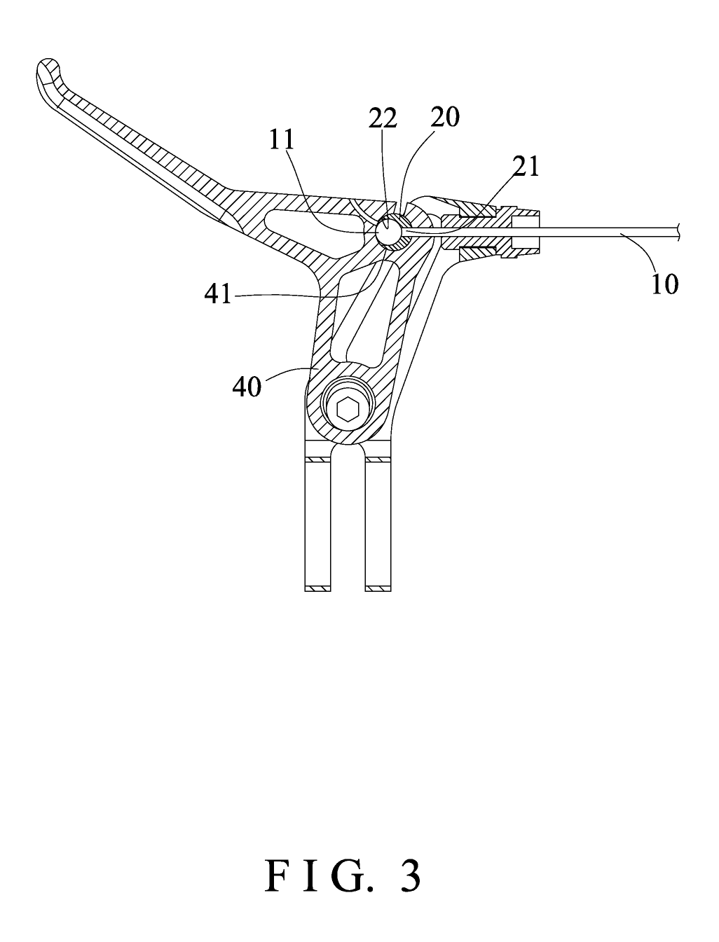

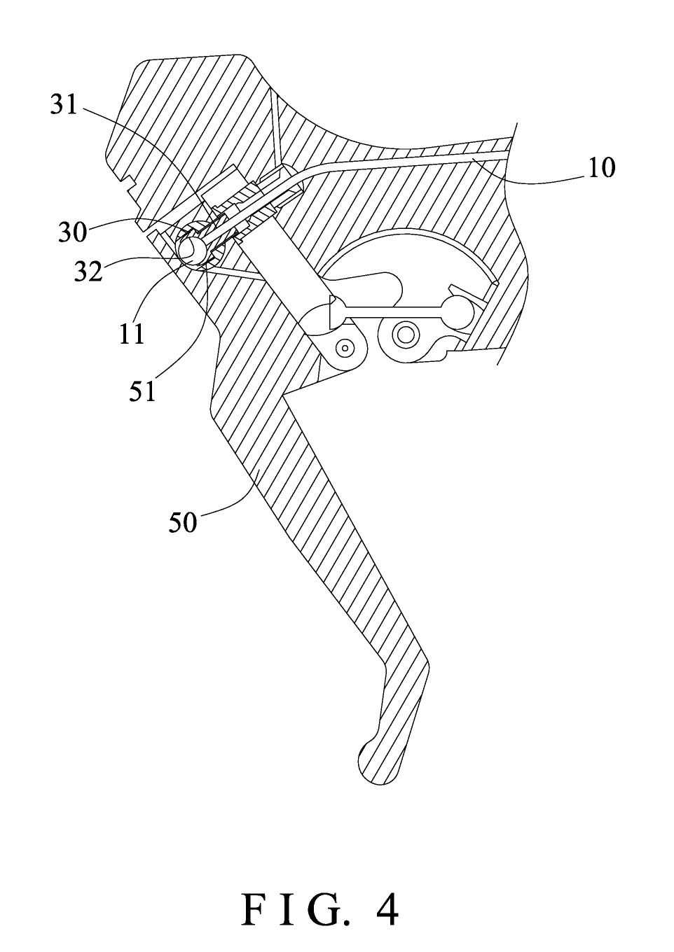

For example, as shown in FIGS. 3 and 4, the brake handles 40, 50 provided for different types of cycles or bicycles each include an aperture or support hole 41, 51 formed therein for receiving or engaging with the couplers 20, 30 and for selectively or changeably attaching or mounting or securing or coupling the cable member 10 to the brake handles 40, 50 of different types of cycles or bicycles. The first coupler 20 and the second coupler 30 each include an aperture or orifice 21, 31 formed therein for receiving or threading or engaging with the cable member 10, and an enlarged recess or depression or cavity or socket opening 22, 32 formed therein and communicating with the orifice 21, 31 respectively for receiving or engaging with the end member 11 of the cable member 10.

The first coupler 20 is provided for one type of the cycles or bicycles and includes a cylindrical shaped-structure having two flat ends 23, 24, and the first orifice 21 and the first socket opening 22 of the first coupler 20 are formed or provided in the middle or intermediate portion 25 thereof for selectively or changeably engaging with the cable member 10 and the end member 11 of the cable member 10. The second coupler 30 is provided for the other type of the cycles or bicycles and includes an enlarged cylindrical head 33 and a relatively reduced or narrowed cylindrical shank 34 extended from the head 33 and having an outer diameter equal to or smaller than or no greater than that of the head 33, in which the second orifice 31 of the second coupler 30 is formed or provided in the shank 34, and the second socket opening 22 of the second coupler 30 is formed or provided in the head 33.

It is to be noted that, as shown in FIG. 3, the cable member 10 may be selectively or changeably engaged with the first coupler 20 for attaching or mounting or securing or coupling to the brake handle 40 of one type of the cycles or bicycles; and as shown in FIG. 4, the cable member 10 may also be selectively or changeably engaged with the second coupler 30 for attaching or mounting or securing or coupling to the brake handle 50 of the other type of the cycles or bicycles, such that the cable member 10 may be may be easily and quickly and readily made or manufactured with a mass production and such that the manufacturing fees and the assembling procedures for the bicycle brake cable combination may be suitably reduced or decreased.

Accordingly, the actuating or operative or pulling bicycle brake cable combination in accordance with the present invention includes a structure for adapting or attaching or mounting or securing or coupling to the brake handles and/or the brake devices of different cycles or bicycles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A brake cable combination comprising:
a cable member including an end member provided on one end portion thereof, said end member of said cable member including a spherical structure,
a first coupler for one bicycle, including a cylindrical shaped-structure, and including a first orifice formed therein for engaging with said cable member, and an enlarged first socket opening formed therein and communicating with said first orifice of said first coupler for receiving and engaging with said end member of said cable member, and
a second coupler for another bicycle, including a head and including a shank extended from said head, and including a second orifice formed in said shank of said second coupler for engaging with said cable member, and including an enlarged second socket opening formed in said head of said second coupler and communicating with said second orifice of said second coupler for receiving and engaging with said end member of said cable member when said end member of said cable member is disengaged from said first socket opening of said first coupler.

2. (canceled)

3. The brake cable combination as claimed in claim 1, wherein said first coupler includes two flat ends, and said first orifice and said first socket opening of said first coupler are formed in a middle portion of said first coupler for engaging with said cable member and said end member.

4. (canceled)

5. The brake cable combination as claimed in claim 1, wherein said head of said second coupler includes a cylindrical structure, and said shank of said second coupler includes a cylindrical structure.

6. The brake cable combination as claimed in claim 5, wherein said shank of said second coupler includes an outer diameter no greater than that of said head of said second coupler.
